(19) United States
(12) Patent Application Publication
(10) Pub. No.: US 2011/0307853 A1
(43) Pub. Date: Dec. 15, 2011

(54) METHOD OF DESIGNING SEMICONDUCTOR INTEGRATED CIRCUIT DEVICE

(75) Inventors: Junichi MANO, Kanagawa (JP); Masafumi Dose, Yokohama (JP); Kimihiro Ogawa, Kanagawa (JP)

(73) Assignees: RENESAS ELECTRONICS CORPORATION; SONY CORPORATION; KABUSHIKI KAISHA TOSHIBA

(21) Appl. No.: 13/159,116

(22) Filed: Jun. 13, 2011

(30) Foreign Application Priority Data
Jun. 15, 2010 (JP) JP2010-135902

(51) Int. Cl. G06F 17/50

(52) U.S. Cl. 716/113

(57) ABSTRACT

A path (different power-supply path) in which verification objective paths pass through two or more power domains is searched from a netlist and power-supply information, and delay-coefficient additional determination is performed in the different power-supply path. In this step, from voltage conditions in each power domain, a voltage condition under which the timing analysis result is most negative is detected, it is determined whether or not the delay coefficient is added for the voltage condition, and the delay coefficient is added. When the delay coefficient is added, the delay coefficient obtained in consideration of the power-supply voltage variation for the delay of the cell belonging to the different power-supply path is extracted from the delay-coefficient information, and is added to the delay value calculated based on the library. Then, based on the delay value to which the delay coefficient is added, the static timing verification is performed.

### CROSS-REFERENCE TO RELATED APPLICATION

The present application claims priority from Japanese Patent Application No. 2010-135902 filed on Jun. 15, 2010, the content of which is hereby incorporated by reference into this application.

### TECHNICAL FIELD OF THE INVENTION

The present invention relates to a timing verification technique in a semiconductor integrated circuit device. More particularly, the present invention relates to a technique effectively applied to timing verification in consideration of power-supply variation in a different power-supply path in a multi power-supply chip.

### BACKGROUND OF THE INVENTION

In recent years, a demand of low power consumption in a semiconductor integrated circuit device has extremely increased. As a technique for the low power consumption, for example, not a technique in which one semiconductor chip is operated by a single supply voltage but so-called multi power-supply chip in which a supply voltage at an optimum voltage level is supplied to each circuit block is known.

In designing this multi power-supply chip, when timing in a logic circuit is verified by STA (static timing analysis) or others, it is required to verify the timing in consideration of power-supply variation of a signal path (hereinafter, referred to as different power-supply path) among a plurality of power supplies of the semiconductor chip since the plurality of power supplies which is supplied from an outside or is generated inside the chip are independently varied in the multi power-supply chip.

In order to totally verify the different power-supply path, it is required for each of all power supplies (voltage levels of all power supplies) to verify a combination of a high voltage to be an upper limit of a voltage-variation allowable range of the power supply and a low voltage to be a lower limit thereof.

### PRIOR ART DOCUMENTS

### Patent Documents

Patent Document 1: Japanese Patent Application Laid-Open Publication No. 2008-262268

Patent Document 2: Japanese Patent Application Laid-Open Publication No. 2004-362192

### SUMMARY OF THE INVENTION

However, in the timing verification technique for the logic circuit in the multi power-supply chip as described above, the following problems have been found out by the present inventors.

As described above, when the different power-supply path is verified, it is required for all power supplies (voltage levels of all power supplies) to verify each combination of the high voltage to be the upper limit of the voltage-variation allowable range of the power supply and the low voltage to be the lower limit thereof, and therefore, the number of times of the verification is 2 to the power of “the number of power-supply types”. For example, if two-type power supplies are provided, four times of the verification are required because the number of times of the verification is 2 to the power of 2.

From the demand of the low power consumption in the semiconductor integrated circuit device, the number of power-supply type of the multi power-supply chip also tends to increase, and, if the number of power-supply type increases, there is a problem that time and/or cost for the verification adversely significantly increase. For example, in a case of a multi power-supply chip for which two-type power-supply voltages are used, 2 to the power of 2 (equal to four) times are required as the number of times of the verification. However, in a case of a multi power-supply chip for which four-type power-supply voltages are used, 2 to the power of 4 (equal to sixteen) times are required as the number of times of the verification.

Here, in the analysis in the case of the multi power-supply chip for which two-type power-supply voltages are used, it is required to verify whether or not the setup error of signals transferred among power supplies, hold-time error thereof, or others exists for four combination cases of “low voltage/low voltage”, “low voltage/high voltage”, “high voltage/low voltage”, and “high voltage/high voltage” of the voltage-variation allowable range of each power supply. Further, if conditions such as temperature variation and device variation are considered, the number of times required for the verification is further multiplied.

Also, an amount of information of a library of others used in the verification also increases as the increase of the number of times of the verification, and therefore, there is a problem that time for storing such information of the library or others in an electronic system via a communication line or others is significantly lengthened.

A preferred aim of the present invention is to provide a technique of allowing effective timing verification of the different power-supply path in the multi power-supply chip in a short time by significantly reducing the number of times of the timing verification.

The above and other preferred aims and novel characteristics of the present invention will be apparent from the description of the present specification and the accompanying drawings.

An outline of the typical ones of the inventions disclosed in the present application will be briefly described as follows.

The present invention is for a method of designing a semiconductor integrated circuit device in which the timing verification of the different power-supply path being the signal path among the plurality of power-supply voltages in the multi power-supply chip is performed by using the electronic system. The method includes: a step of searching the different power-supply path in the multi power-supply chip; a step of determining a power-supply condition at the most-negative timing of the different power-supply path in the multi power-supply chip, determining whether or not a delay coefficient is added to a delay value of a cell belonging to the different power-supply path under the determined power-supply condition, and adding the delay coefficient based on the determined result; and a step of performing the timing verification by using the power-supply condition and the added delay coefficient.

Also, an outline of another invention of the present application will be briefly described.

In the present invention, the power-supply condition is set to the upper limit voltage of the voltage-variation allowable range of the power-supply voltage and the delay coefficient is added to the delay value of each cell on a capture side in the hold-time analysis, the power-supply condition is set to the lower limit voltage of the voltage-variation allowable range of the power-supply voltage and the delay coefficient is added to the delay value of each cell on a launch side in the hold-time analysis, the power-supply condition is set to the upper limit voltage of the voltage-variation allowable range of the power-supply voltage and the delay coefficient is added to the delay value of each cell on the launch side in the setup-time analysis, and the power-supply condition is set to the lower limit voltage of the voltage-variation allowable range of the power-supply voltage and the delay coefficient is added to the delay value of each cell on the capture side in the setup-time analysis.

Also, in the present invention, total delay values on the launch side and the capture side are calculated for each power domain in the different power-supply path. In the case of the hold-time analysis, for the power domain having the total delay value on the capture side larger than that on the launch side, the delay coefficient is added to the delay value of each cell of the power domain, and, in the case of the setup-time analysis, for the power domain having the total delay value on the capture side smaller than that on the launch side, the delay coefficient is added to the delay value of each cell of the power domain.

Further, in the present invention, total delay differences on the launch side and the capture side are calculated for each power domain in the different power-supply path. In the case of the hold-time analysis, for the power domain having the total delay difference on the launch side smaller than that on the capture side, the delay coefficient is added to the delay value of each cell of the power domain, and, in the case of the setup-time analysis, for the power domain having the total delay difference on the launch side larger than that on the capture side, the delay coefficient is added to the delay value of each cell of the power domain, and the delay difference is obtained by multiplying the delay value by the delay coefficient.

Still further, in the present invention, the delay coefficient is calculated from a formula of “(the delay value in the lower limit voltage of the voltage-variation allowable range of the power-supply voltage/the delay value in the upper limit voltage thereof)−1”.

The effects obtained by typical aspects of the present invention disclosed in the present application will be briefly described below.

(1) The time for the timing verification in the semiconductor integrated circuit device with using the multi power-supply chip can be significantly reduced.

(2) By the above-described (1), the development period can be shortened as reducing the designing cost of the semiconductor integrated circuit device.

### BRIEF DESCRIPTIONS OF THE DRAWINGS

FIG. 1 is a flowchart illustrating an example of timing verification according to an embodiment of the present invention;

FIG. 2 is an explanatory diagram showing an example of delay-coefficient additional determination techniques used in a process of a step S102 of FIG. 1;

FIG. 3 is an explanatory diagram showing an example of determination conditions of a determination technique 1 of FIG. 2;

FIG. 4 is an explanatory diagram illustrating an example of hold-time analysis with using the determination condition of FIG. 3;

FIG. 5 is an explanatory diagram showing an example of determination conditions of a determination technique 2 of FIG. 2;

FIG. 6 is an explanatory diagram showing an example of a hold-time analysis determination according to the determination technique 2 shown in FIG. 5;

FIG. 7 is an explanatory diagram illustrating an example of a different power-supply path used for the determination example of FIG. 6;

FIG. 8 is an explanatory diagram showing an example of determination conditions of a determination technique 3 of FIG. 2;

FIG. 9 is an explanatory diagram showing an example of a hold-time analysis determination according to the determination technique 3 shown in FIG. 8;

FIG. 10 is an explanatory diagram illustrating an example of a different power-supply path used for the determination example of FIG. 9;

FIG. 11 is an explanatory diagram showing an example of storing delay-coefficient information;

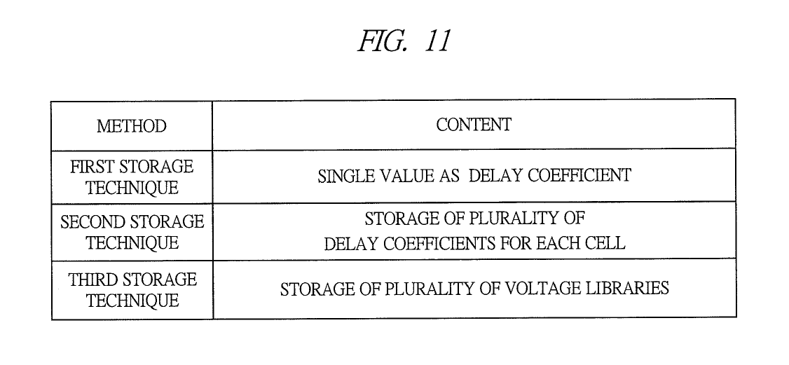

FIG. 12 is a flowchart illustrating an example of timing verification of a different power-supply path in a general multi power-supply chip studied by the inventors;

FIG. 13 is an explanatory diagram showing an example of a combination of power-supply conditions in the timing verification of FIG. 12; and

FIG. 14 is a flowchart illustrating an example of timing verification according to another embodiment of the present invention.

### DESCRIPTIONS OF THE PREFERRED EMBODIMENTS

Hereinafter, embodiments of the present invention will be described in detail with reference to the accompanying drawings. Note that the same components are denoted by the same reference symbols throughout the drawings for describing the embodiments, and the repetitive description thereof will be omitted.

In the present embodiment, as the timing verification of the verification objective path (signal path) in the semiconductor integrated circuit device, the verification is performed in a multi power-supply chip supplying power-supply voltages at a plurality of voltage levels to each arbitrary circuit block.

In the timing verification, by searching a different power-supply path and adding a delay coefficient calculated in consideration of power-supply voltage variation to a delay of a cell belonging to the different power-supply path, the delay of the different power-supply path is calculated and verified. That is, the timing verification has an effect of reducing the number of processes for the verification and/or the required library data by previously obtaining and verifying the most-negative delay coefficient in the case of the voltage variation.

The timing verification of the cell in the semiconductor integrated circuit device is processed by an electronic system including a computer system exemplified by a personal computer, a workstation, or others.

The electronic system includes, for example: an input unit; a central control unit; an output unit; a database; and others. The input unit is a keyboard or others by which various data can be inputted, and the central control unit is connected to the input unit.

The output unit is, for example, a display, a printer, or others, and it displays the data inputted from the input unit, the result calculated by the central control unit, or others, or it performs print output. The database stores various types of information such as the netlist, the library, the power-supply information, the delay-coefficient information, and others, which are used for the timing verification in the semiconductor integrated circuit device.

In the netlist, a connection of the cell in the semiconductor integrated circuit device is written, and this corresponds to a circuit diagram and wire-connection information. In the library, the delay value of the cell in the semiconductor integrated circuit device is written, and this is table-form information whose value depends on an input slew value of the cell and an output load capacitance of the cell.

Also, in the power-supply information, information about which power domain each cell belongs to is written, and this is a so-called power format. In the delay-coefficient information, a delay coefficient (safety coefficient) used in the timing verification is written.

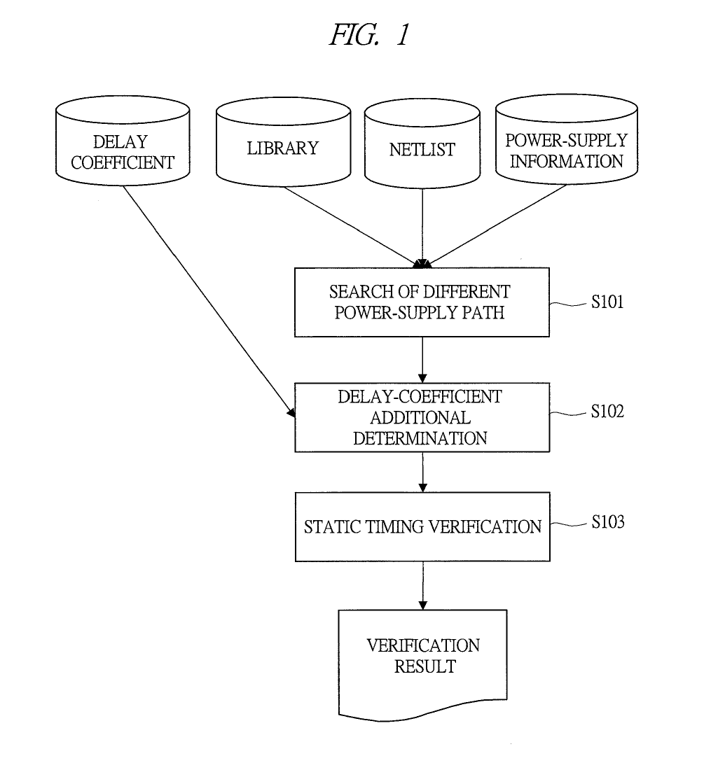

FIG. 1 is a flowchart illustrating an example of a static timing verification process of the cell in the semiconductor integrated circuit device.

First, a different power-supply path being a signal path among a plurality of power supplies in the semiconductor integrated circuit device is searched (step S101). This process is for searching a path in which the verification objective paths (launch and capture paths) pass through two or more power domains from two of the netlist and the power-supply information, and is a preliminary process for extracting only a path by which signals are transferred between different power-supplies and verifying it.

Subsequently, the delay-coefficient additional determination is performed for the different power-supply path searched by the process of the step S101 (step S102). In this step, a voltage condition, under which the timing analysis result is most negative, of voltage conditions of each power domain is detected, it is determined whether or not the delay coefficient is added to the voltage condition, and the delay coefficient is added.

Here, the voltage condition is a combination of the upper limit voltage of the voltage-variation allowable range of the power-supply voltage supplied to each power domain of the different power-supply path and the lower limit voltage of the voltage-variation allowable range of the power-supply voltage supplied thereto. For example, if two-type power-supply voltages are used, the voltage condition is four types obtained by combinations of 2 to the power of 2 (equal to 4).

When the delay coefficient is added, the delay coefficient obtained in consideration of the power voltage variation for the delay of the cell belonging to the different power-supply path is extracted from the delay-coefficient information, and the delay coefficient is added to the delay value calculated based on the library.

Then, in the process of the step S102, the static timing verification is performed based on the delay coefficient added to the delay value (step S103). The timing verification in the step S103 is a process for verifying whether or not the time obtained by subtracting the capture path delay time from the launch path delay time is within a certain range. It is checked whether or not the time is too long in the setup-time analysis and the time is too short in the hold-time analysis.

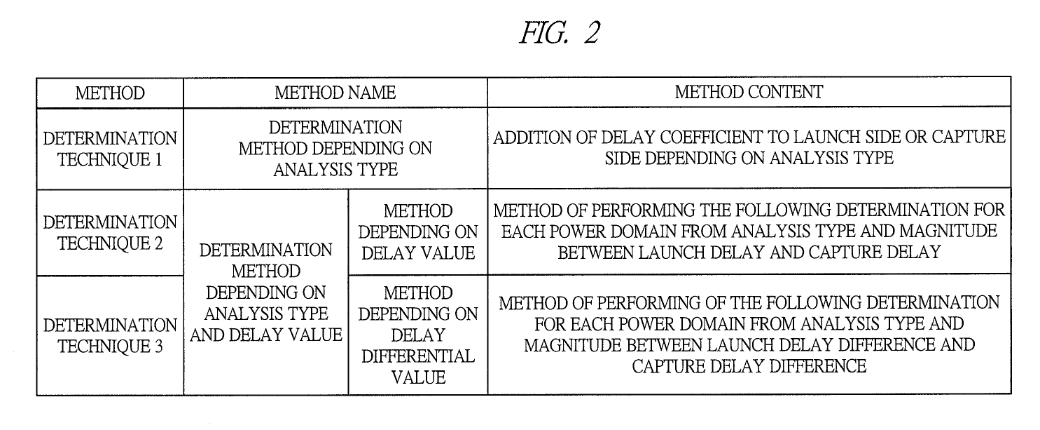

FIG. 2 is an explanatory diagram showing an example of a technique for the delay-coefficient additional determination used in the process of the step S102 of FIG. 1.

As the technique for the delay-coefficient additional determination, determination techniques 1 to 3 are cited as shown. In the determination technique 1, the delay coefficient is added to the launch side or the capture side depending on the analysis type (the hold-time analysis or the setup-time analysis). In the determination technique 2, the addition is determined for each power domain from the analysis type and a magnitude between the launch delay and the capture delay.

Also, in the determination technique 3, the addition is determined for each power domain from the analysis type and a magnitude between the launch delay difference and the capture delay difference.

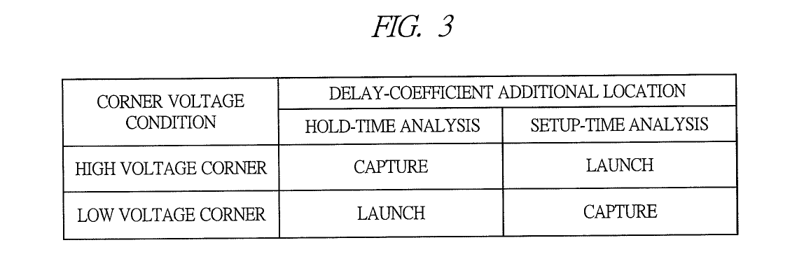

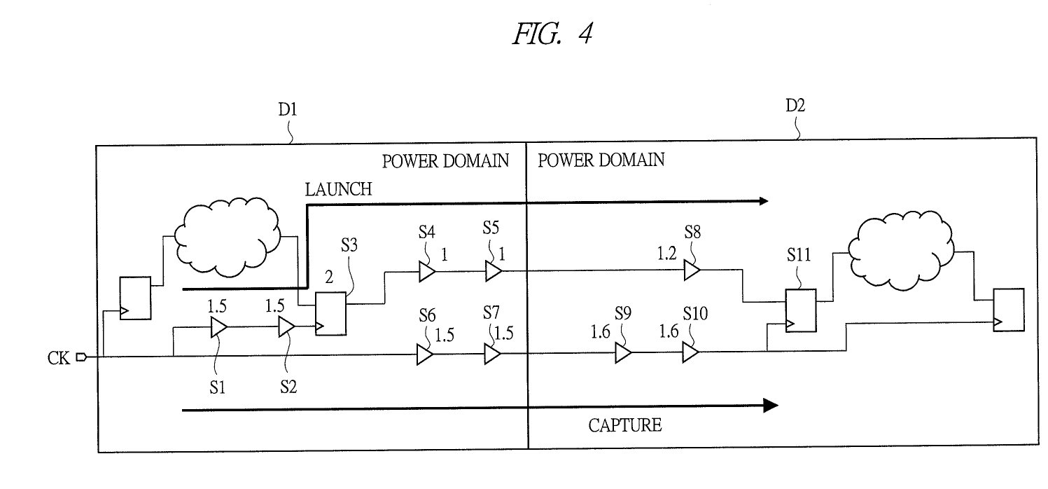

FIG. 3 is an explanatory diagram showing an example of determination conditions of the determination technique 1, and FIG. 4 is an explanatory diagram illustrating an example of the hold-time analysis with using the determination condition of FIG. 3. In FIG. 3, a high-voltage corner represents the upper limit voltage of the voltage-variation allowable range of the power supply, and a low-voltage corner represents the lower limit voltage of the voltage-variation allowable range of the power supply.

In FIG. 4, a power domain D1 and a power domain D2 are areas to which power-supply voltages different from each other are supplied, and cells S1 to S7 are provided in the power domain D1 and cells S8 to S11 are provided in the power domain D2. Each of the cell S3 of the power domain D1 and the cell S11 of the power domain D2 is configured by a flip flop. Also, numbers shown above the cells S1 to S10 in FIG. 4 represent the delay values calculated based on the library.

A clock signal “CK” is inputted to the cell S3 via the cells S1 and S2, and the clock signal CK is inputted to the cell S11 via the cells S6, S7, S9, and S10. Further, an output of the cell S3 is connected so that the output is inputted to the cell S11 via the cells S4 and S5.

In this case, when the voltage condition is the high-voltage corner, in the hold-time analysis, the delay coefficient loaded from the delay-coefficient information is added to each cell on the capture side as shown in FIG. 3.

For example, in FIG. 4, the delay coefficient loaded from the delay-coefficient information is added (for example, summed) to each delay value “1.5” of the cells S6 and S7 of the power domain D1, and the delay coefficient loaded from the delay-coefficient information is added to each delay value “1.6” of the cells S9 and S10 of the power domain D2. The analysis is performed under the above conditions to determine whether or not the hold-time condition is satisfied.

Also, in the hold-time analysis when the voltage condition is the low-voltage corner, as shown in FIG. 3, the delay coefficient is added to each cell on the launch side. Therefore, as illustrated in FIG. 4, the delay coefficient loaded from the delay-coefficient information is added to each delay value of the cells S1 to S5 of the power domain D1, and the delay coefficient loaded from the delay-coefficient information is added to the delay value “1.2” of the cell S8 of the power domain D2.

The analysis is performed under the above conditions to determine whether or not the hold-time condition is satisfied. Further, in the setup-time analysis shown in FIG. 3, similarly to the above descriptions, the delay coefficient is added to the launch side in the high-voltage corner and the capture side in the low-voltage corner, and it is verified whether or not each of the hold- and setup-time conditions is satisfied. In this manner, as compared with a conventional manner, the number of steps for the verification and an amount of the required data for the library or others can be significantly reduced.

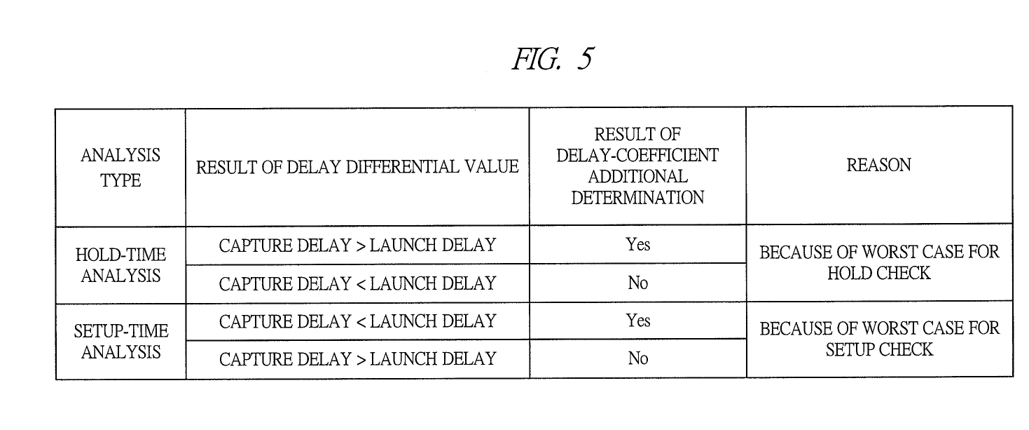

FIG. 5 is an explanatory diagram showing an example of determination conditions of the determination technique 2.

In the determination technique 2, in the voltage variation from the high-voltage corner to the low-voltage corner, the launch delay and the capture delay are calculated for each power domain. As shown in FIG. 5, in the hold-time analysis, if the capture delay is larger than the launch delay in a certain power domain, the delay coefficient is added to each cell of the power domain.

Also, in the setup-time analysis, if the capture delay is smaller than the launch delay in a certain power domain, the delay coefficient is added to the delay value of each cell of the power domain having the capture delay smaller than the launch delay. If the capture delay is smaller than the launch delay in the hold-time analysis, and if the capture delay is larger than the launch delay in the setup-time analysis, the delay coefficient is not added to the delay value of each cell thereof.

From these conditions, the worst condition can be provided for each of the setup-time analysis and the hold-time analysis. The setup time and hold time are evaluated for the path to which the delay coefficient is added by the above-described operations, so that the number of steps for the verification and the amount of the required data for the library or others can be significantly reduced as compared with the conventional manner.

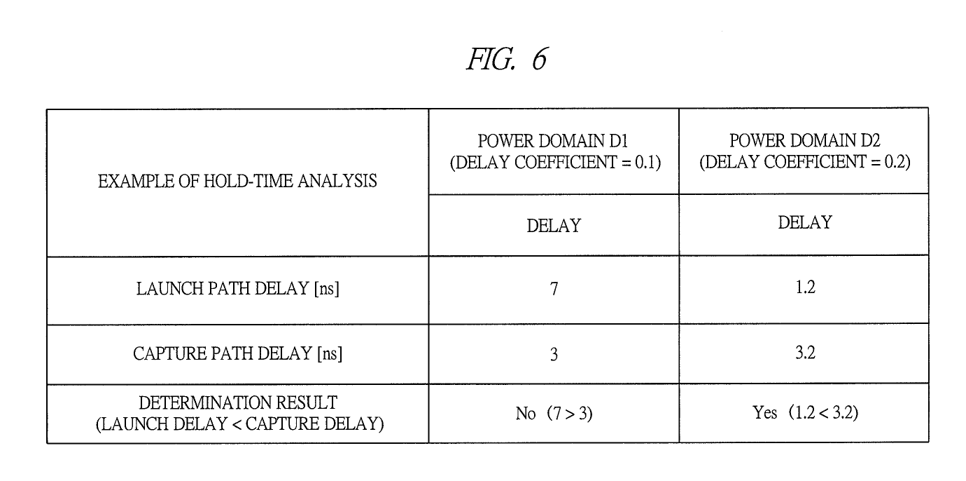

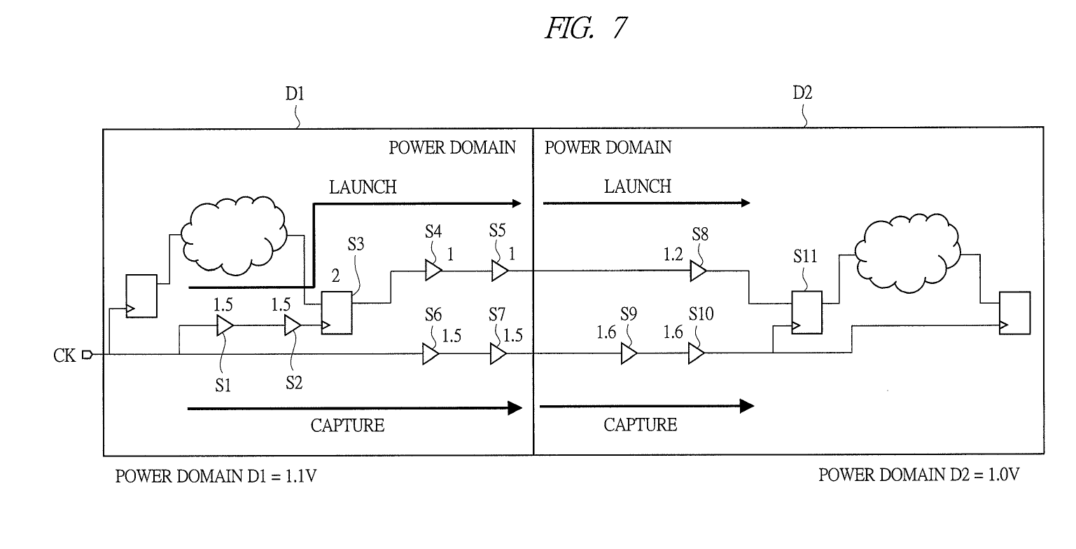

FIG. 6 is an explanatory diagram showing an example of the hold-time analysis determination according to the determination technique 2 shown in FIG. 5, and FIG. 7 is an explanatory diagram illustrating an example of the different power-supply path used for the determination example of FIG. 6.

The different power-supply path in FIG. 7 has the same structure as that of FIG. 4, the structure includes the power domain D1 and the power domain D2 to which different power-supply voltages are supplied, and cells S1 to S7 are provided in the power domain D1 and cells S8 to S11 are provided in the power domain D2. Also, their connection structures are the same as those of FIG. 4 . Further, numbers shown above the cells S1 to S10 in FIG. 7 represent the delay value calculated based on the library as the same as those of FIG. 4.

First, the delays on the launch side and the capture side of the power domain D1 and the power domain D2 are obtained. Here, as shown in FIG. 6, a total delay value of a path through the cells S1 to S5 on the launch side of the power domain D1 is “7”, and a delay value of a path through the cell S8 on the launch side of the power domain D2 is “1.2”.

Also, a total delay value of a path through the cells S6 and S7 on the capture side of the power domain D1 is “3”, and a total delay value of a path through the cells S9 and S10 on the capture side of the power domain D2 is “3.2”.

And, the path delay on the launch side and the path delay on the capture side obtained in the power domains D1 and D2 are compared with each other, and, if the path delay on the launch side is smaller than the path delay on the capture side, the delay coefficient is added. This is because, if the capture delay is larger than the launch delay, the worst case of the hold violation is provided.

Here, it is set that, for example, the delay coefficient of the power domain D1 is “0.1” and the delay coefficient of the power domain D2 is “0.2”, and each delay coefficient is the same value for all cells of each power domain for simplification.

In the power domain D1 in FIG. 6, since the total delay value of the launch-side path is “7” and the total delay value of the capture-side path is “3”, the delay coefficient is not added to the cells of the power domain D1.

On the other hand, in the power domain D2, since the total delay value of the launch-side path is “1.2” and the total delay value of the capture-side path is “3.2”, the delay coefficient “0.2” is added (for example, summed) to the cells S8 to S10 of the power domain D2.

In this case, in the power domain D2, the delay of the cell S8 becomes “1.4” by adding the delay coefficient “0.2” to the delay value “1.2”, and each delay of the cells S9 and S10 becomes “1.8” by adding the delay coefficient “0.2” to the delay value “1.6”.

By using the determination technique 2, similarly to the determination technique 1, the number of steps for the verification and the amount of the required data for the library or others can be significantly reduced as compared with the conventional manner, and the higher-accurate delay-coefficient additional determination can be performed than that of the determination technique 1.

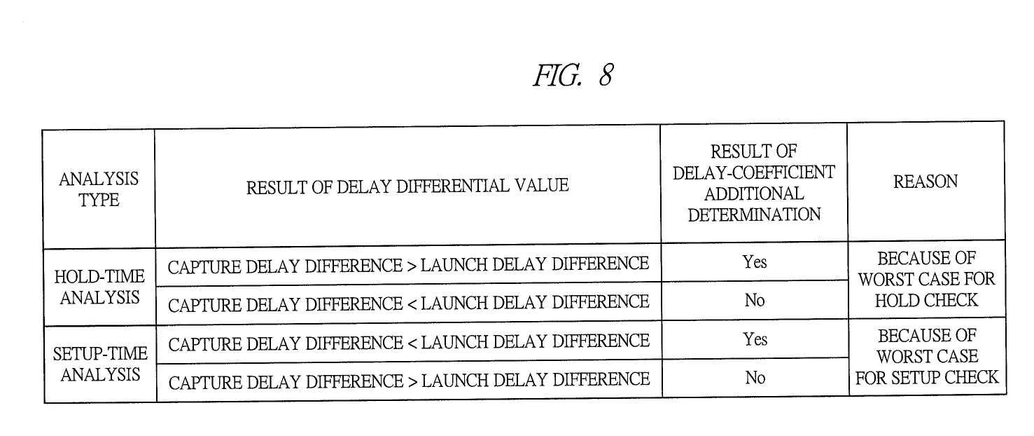

FIG. 8 is an explanatory diagram showing an example of a determination condition of the determination technique 3.

In the determination technique 3, in the voltage variation from the high-voltage corner to the low-voltage corner, delay differential values on the launch side and the capture side are calculated for each power domain. Here, the delay difference is expressed by a formula of “the delay difference=the delay×the delay coefficient” and a formula of “the delay value with the difference=the delay value+(the delay×the delay coefficient)”.

As shown in FIG. 8, in the hold-time analysis, if the delay difference on the capture side is larger than the delay difference on the launch side, the delay coefficient is added to the corresponding power domain. In this manner, the worst condition can be provided for hold-time check.

Also, in the setup-time analysis, if the delay difference on the capture side is smaller than the delay difference on the launch side, the delay coefficient is added to the corresponding power domain. In this manner, the worst condition can be provided for setup-time check.

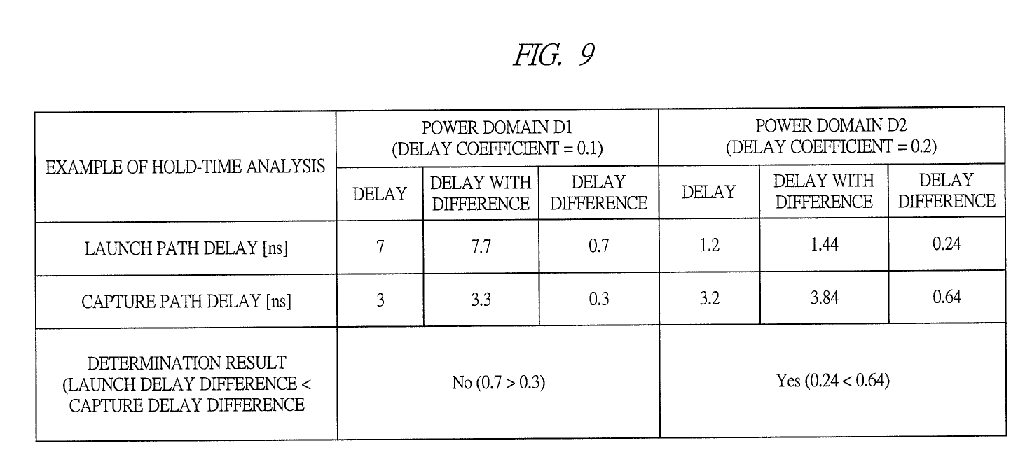

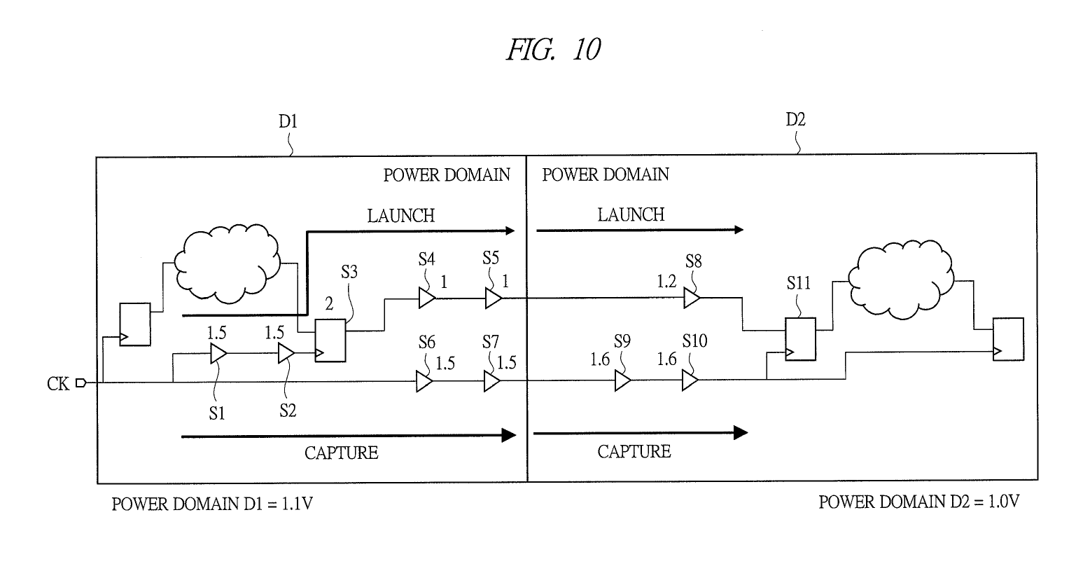

FIG. 9 is an explanatory diagram showing an example of the hold-time analysis determination according to the determination technique 3 shown in FIG. 8, and FIG. 10 is an explanatory diagram illustrating an example of the different power-supply path used for the determination example of FIG. 9.

Also in FIG. 10, the different power-supply path is the same as that of FIG. 4, and the cells S1 to S7 are provided in the power domain D1 and the cells S8 to S11 are provided in the power domain D2. Further, numbers shown above the cells S1 to S10 in FIG. 10 also represent the delay values calculated based on the library or others as the same as those of FIG. 4.

Still further, it is set that the delay coefficient of the power domain D1 is “0.1” and the delay coefficient of the power domain D2 is “0.2”, and each delay coefficient is the same value for all cells of each power domain for simplification.

First, the delay value of the launch-side path of the power domain D1 is “7” as seen from FIG. 10, and the delay value with the difference is “7.7”. Similarly, the delay value of the capture-side path of the power domain D1 is “3” as seen from FIG. 10, and the delay value with the difference is “3.3”.

Therefore, the delay difference “0.3” of the capture-side path is smaller than the delay difference “0.7” of the launch-side path, and thus, the delay coefficient is not added in the power domain D1.

Subsequently, the delay value of the launch-side path of the power domain D2 is “1.2” as seen from FIG. 10, and the delay value with the difference is “1.44”. Similarly, the delay value of the capture-side path of the power domain D2 is “3.2” as seen from FIG. 10, and the delay value with the difference is “3.84”.

In this case, the delay difference “0.64” of the capture-side path is larger than the delay difference “0.24” of the launch-side path, and thus, the delay coefficient “0.2” is summed to each delay value of the cells S8 to S10.

Also, as a method of how to store the information of the above-described delay coefficients (delay-coefficient information), there is, for example, a first storage technique which stores the delay coefficient as a single value, a second storage technique which has a plurality of delay coefficients for each cell, a third storage technique which has a plurality of voltage libraries so as to provide the same effect as that of the second storage technique, or others.

Next, the extraction technique for the delay coefficients will be described.

The delay coefficient is a delay ratio between different voltages such as a delay ratio between the lower limit voltage of the voltage-variation allowable range of the power-supply voltage and the upper limit voltage thereof, and is expressed by the following formula.

“the delay coefficient (delay ratio)=the delay (lower limit voltage)/the delay (upper limit voltage)−1”

Here, relations of “the lower limit voltage=the power-supply voltage VDD−ΔV” and “the upper limit voltage=the power-supply voltage VDD+ΔV” are established.

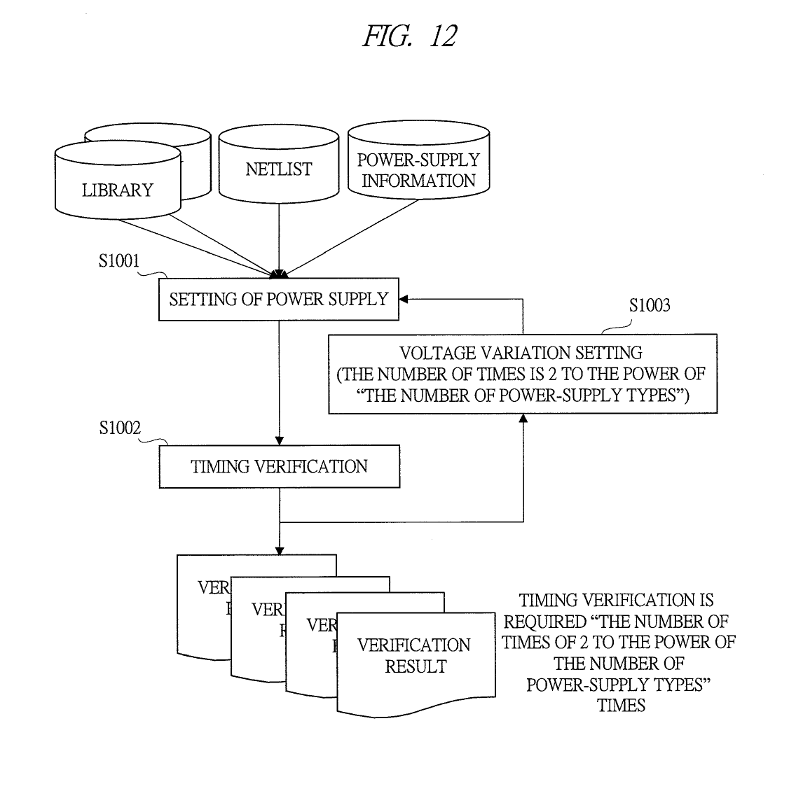

FIG. 12 is a flowchart illustrating an example of the timing verification of the different power-supply path in a general multi power-supply chip studied by the inventors.

In this case, as illustrated, the library, the netlist, and the power-supply information are loaded for setting the power-supply (step S1001). This setting is for setting voltage conditions of power-supply voltages of a power domain D50 and a power domain D51 which are required for the verification.

Subsequently, the timing verification is performed under the setting voltage conditions (step S1002), the voltage conditions are newly set until the number of times of the verification reaches 2 to the power of “the number of power-supply types”, and the processes of the steps S1001 and S1002 are repeated (step S1003).

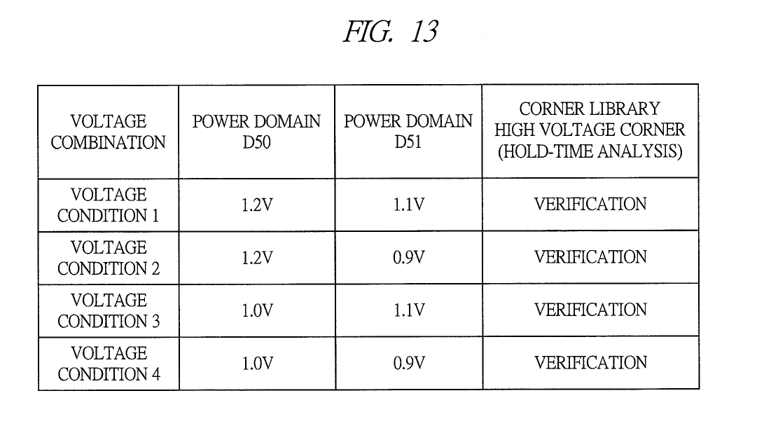

In the setting of the voltage condition, for example, when it is set that the voltage-variation allowable range of the power domain D50 is “1.1 V±0.1 V” and the voltage-variation allowable range of the power domain D51 is “1.0 V±0.1 V”, 4 types (2 to the power of “the number of power-supply types”) of voltage conditions 1 to 4 are set as the power supplies as shown in FIG. 13. As the timing verification for them, total eight times of four times in the capture-side path and four times in the launch-side path are performed.

In this manner, in the multi power-supply chip, for example, the timing variation in consideration of the independent voltage variation in the power domain D50 and the power domain D51 is required, and, as a result, the timing verification is performed 2 to the power of “the number of power-supply types” times.

On the other hand, in the present invention, the delay coefficient in the voltage variation (between the lower limit voltage of the voltage-variation allowable range and the upper limit voltage thereof) is previously obtained, the coefficient to be most negative is obtained in the timing verification, and the timing verification is performed by using the coefficient, so that the number of times of the timing verification can be only once (total twice of once in the capture-side path and once in the launch-side path).

In this manner, according to the present embodiment, the number of times of the timing verification can be significantly reduced, and therefore, the period for the timing verification can be shortened, and the manufacturing efficiency of the semiconductor integrated circuit device can be improved.

Also, the number of libraries used for the timing verification can be significantly reduced.

Further, in the present embodiment, the case that the present invention is applied for the static timing verification has been described. However, the present invention can be also applied for, for example, dynamic timing verification.

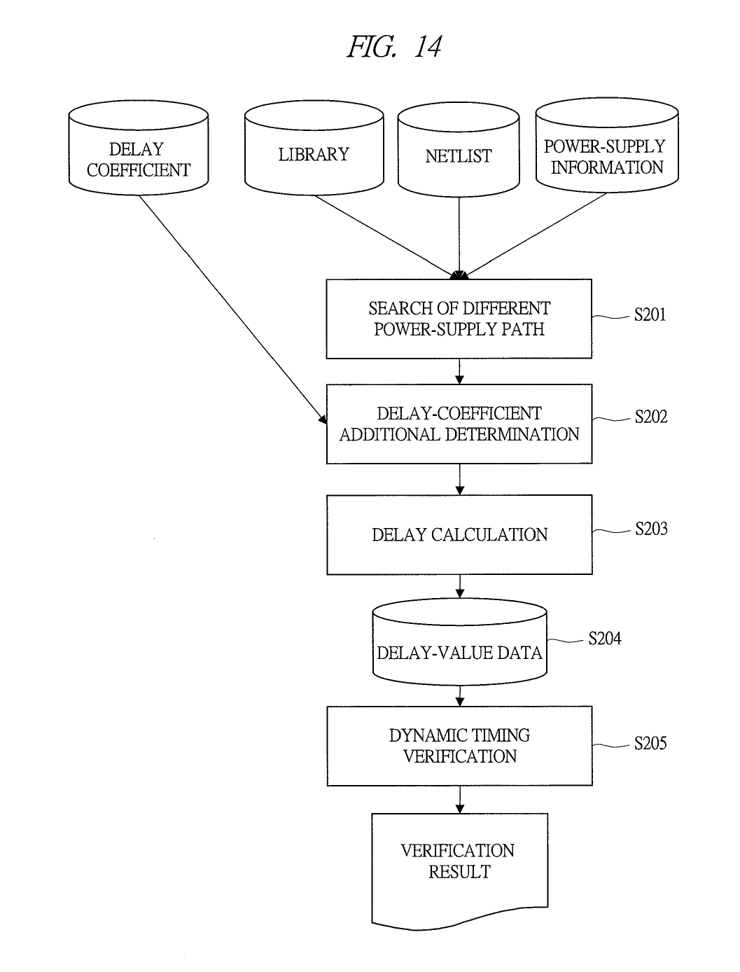

FIG. 14 is a flowchart illustrating an example of the dynamic timing verification in the multi power-supply chip.

First, the different power-supply path is searched from the netlist and the power-supply information for searching a path in which verification objective paths (launch-side and capture-side paths) pass through two or more power domains (step S201).

Subsequently, by using the determination techniques (for example, see FIGS. 3, 5, and 8) described in the embodiment, it is determined whether or not the delay coefficient is added (step S202). Based on the determination result in the process of the step S202, the delay of all cells and nets (wires) is calculated (step S203), and this result is outputted to a file or others in order to pass the result to the dynamic timing verification (step S204). At this time, as the delay of the cell which is determined so that the delay coefficient is added in the delay additional determination, the delay is calculated so as to provide the delay with the addition.

And, a logic circuit simulation to which the result of the delay value is reflected is executed, and the dynamic timing verification of outputting the result is executed (step S205).

Also in this manner, the number of times of the timing verification can be significantly reduced, and the period for the timing verification can be shortened.

In the foregoing, the invention made by the inventors has been concretely described based on the embodiments. However, it is needless to say that the present invention is not limited to the foregoing embodiments and various modifications can be made within the scope of the present invention.

The present invention is suitable for the timing verification technique in the semiconductor integrated circuit device with using the multi power-supply chip.

What is claimed is:

1. A method of designing a semiconductor integrated circuit device in which timing verification of a different power-supply path being a signal path among a plurality of power-supply voltages in a multi power-supply chip is performed by using an electronic system,
the method comprising the steps of:
searching the different power-supply path in the multi power-supply chip;
determining a power-supply condition of providing the most-negative timing of the different power-supply path in the multi power-supply chip, determining whether or not a delay coefficient is added to a delay value of a cell belonging to the different power-supply path under the determined power-supply condition, and adding the delay coefficient based on a result of the determination; and
performing the timing verification by using the power-supply condition and the added delay coefficient.

2. The method of designing the semiconductor integrated circuit device according to claim 1, wherein,
in the step of adding the delay coefficient,
the power-supply condition is set to an upper limit voltage of a voltage-variation allowable range of the power-supply voltage and the delay coefficient is added to a delay value of each cell on a capture side in hold-time analysis, the power-supply condition is set to a lower limit voltage of the voltage-variation allowable range of the power-supply voltage and the delay coefficient is added to a delay value of each cell on a launch side in the hold-time analysis, the power-supply condition is set to the upper limit voltage of the voltage-variation allowable range of the power-supply voltage and the delay coefficient is added to the delay value of each cell on the launch side in setup-time analysis, and the power-supply condition is set to the lower limit voltage of the voltage-variation allowable range of the power-supply voltage and the delay coefficient is added to the delay value of each cell on the capture side in the setup-time analysis.

3. The method of designing the semiconductor integrated circuit device according to claim 1, wherein,
in the step of adding the delay coefficient,
each total delay value on a launch side and a capture side is calculated for each power domain in the different power-supply path, and, in hold-time analysis, for a power domain having the total delay value on the capture side larger than the total delay value on the launch side, the delay coefficient is added to a delay value of each cell of the power domain, and, in setup-time analysis, for a power domain having the total delay value on the capture side smaller than the delay value on the launch side, the delay coefficient is added to a delay value of each cell of the power domain.

4. The method of designing the semiconductor integrated circuit device according to claim 1, wherein,
in the step of adding the delay coefficient,
each total delay difference on a launch side and a capture side is calculated for each power domain in the different power-supply path, and, in hold-time analysis, for a power domain having the total delay difference on the launch side smaller than the total delay difference on the capture side, the delay coefficient is added to a delay value of each cell of the power domain, and, in setup-time analysis, for a power domain having the total delay difference on the launch side larger than the total delay difference on the capture side, the delay coefficient is added to a delay value of each cell of the power domain, and
the delay difference is obtained by multiplying the delay value by the delay coefficient.

5. The method of designing the semiconductor integrated circuit device according to claim 1, wherein
the delay coefficient is calculated from a formula of [(delay value in a lower limit voltage of a voltage-variation allowable range of the power-supply voltage)/(delay value in an upper limit voltage of the voltage-variation allowable range of the power-supply voltage)−1].

6. The method of designing the semiconductor integrated circuit device according to claim 2, wherein
the delay coefficient is calculated from a formula of [(delay value in a lower limit voltage of a voltage-variation allowable range of the power-supply voltage)/(delay value in an upper limit voltage of the voltage-variation allowable range of the power-supply voltage)−1].

7. The method of designing the semiconductor integrated circuit device according to claim 3, wherein
the delay coefficient is calculated from a formula of [(delay value in a lower limit voltage of a voltage-variation allowable range of the power-supply voltage)/(delay value in an upper limit voltage of the voltage-variation allowable range of the power-supply voltage)−1].

8. The method of designing the semiconductor integrated circuit device according to claim 4, wherein
the delay coefficient is calculated from a formula of [(delay value in a lower limit voltage of a voltage-variation allowable range of the power-supply voltage)/(delay value in an upper limit voltage of the voltage-variation allowable range of the power-supply voltage)−1].
